(19) United States
(12) Patent Application Publication
(10) Pub. No.: US 2019/0119477 A1
(43) Pub. Date: Apr. 25, 2019

(54) Propylene-Based Films with Improved Barrier Properties

(71) Applicant: ExxonMobil Chemical Patents Inc., Baytown, TX (US)

(72) Inventors: Etienne R. H. Lernoux, Longueville (BE); Lanya Cheng, Shanghai (CN)

(21) Appl. No.: 16/015,650

(22) Filed: Jun. 22, 2018

Related U.S. Application Data
(60) Provisional application No. 62/576,921, filed on Oct. 25, 2017.

(51) Int. Cl. C08L 23/12; C08J 5/18; B32B 27/08; B32B 27/32

(52) U.S. Cl. CPC C08L 23/12; B32B 2439/70; B32B 27/08; B32B 27/32; C08L 2203/162; C08L 2205/025; C08L 2205/035; C08J 2323/12; C08J 2423/14; C08J 2423/12; B32B 2250/40; B32B 2250/242; B32B 2307/7246; B32B 2307/7244; B32B 2307/7248; C08J 5/18

(57) ABSTRACT

The present invention provides a film including at least one layer that comprises a propylene polymer and a hydrocarbon resin. The films disclosed herein generally have improved barrier properties as compared to films free of the hydrocarbon resin.

### CROSS-REFERENCE TO RELATED APPLICATIONS

This application claims priority to U.S. Ser. No. 62/576,921, filed Oct. 25, 2017, herein incorporated by reference.

### FIELD OF THE INVENTION

The present invention relates to propylene-based films, and in particular, to barrier films suitable for food packaging applications.

### BACKGROUND OF THE INVENTION

Plastics have found utility in a wide variety of flexible packaging applications such as bags, pouches, tubes, films, or rigid packaging applications such as trays.

When such plastics are used as food packaging materials, the barrier to water vapor and gases (such as oxygen and nitrogen) is critical for the shelf-life of the packed product. An enhanced barrier to water vapor allows a dry product to remain dry, or a wet product to keep its moisture content at an acceptable level. An enhanced gas barrier allows a modified atmosphere to stay longer inside the bag or slows down the permeation of external gases such as oxygen into the bag.

Barrier to aroma is also a desired attribute. Aromas are typically large molecules that can permeate through the film with time. This can translate into aroma loss from the packed product, or into contamination of the packed product by external aromas migrating from the environment in which the pack is placed.

It is known that some polar materials, such as polyethylene terephthalate (PET), polyamide (PA), ethylene vinyl alcohol (EVOH) or polyvinylidene chloride (PVdC), which provide efficient barrier to gases such as oxygen or nitrogen, are also good barriers to aroma permeation.

Polypropylene (PP) and polyethylene (PE), which are polyolefins used in packaging, are known to have poor barrier to gases and aroma permeation. However, they have good barrier to water vapor, and improving this barrier can be critical to shelf-life.

Some techniques are used to reinforce barrier to gases, aroma or water vapor of PP or PE packaging. For instance, they can be coextruded with a polar polymer such as PA, EVOH or PVdC, which will significantly reduce the permeation of gas and aromas.

PP or PE films can also be coated with barrier coatings. For instance, a PVdC-coating will improve the barrier to gases, water-vapor and aromas. Some acrylic coatings will significantly improve aroma barriers, but be of no effect on water-vapor and gas barriers.

Metallization of the films with aluminum is another frequently used technique to increase barriers of polyolefin packaging. It can drastically enhance gas and moisture barrier, but is typically less efficient in improving the aroma barrier. It also makes the packaging opaque, which is not always desired.

All these techniques to improve barrier of polyolefin packaging, although very efficient, increase the packaging cost quite significantly. They can also affect other properties such as sealing, clarity, etc. For example, U.S. Pat. No. 5,213,744 discloses a polyolefin film including a resin or rosin, which may have improved stiffness, clarity, heat sealability and/or barrier properties. U.S. Pat. No. 7,314,901 discloses a polypropylene film can comprise high crystallinity polypropylene, a conventional polypropylene, and a hydrocarbon resin. However, neither reference addresses aroma barrier properties.

Therefore, there still is a need to improve water vapor, gas, and aroma barriers of polyolefin films such as PP or PE, without having to coextrude or coat barrier polymers and without having to metallize the films.

### SUMMARY OF THE INVENTION

This invention provides a film comprising a first layer, A, which comprises from about 40 wt % to about 99 wt % of a propylene polymer and from about 1 to about 60 wt % of a hydrocarbon resin, based on the total weight of the first layer; wherein the propylene polymer is a propylene homopolymer, or a copolymer of propylene having at least one comonomer selected from ethylene and C₄-C₂₀ alpha-olefins, wherein the copolymer has a propylene content of at least about 80 wt % and has a melting point of greater than about 115° C. and wherein the hydrocarbon resin is selected from the group consisting of an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and combinations thereof; and wherein the film further comprises a second layer, B, comprising a copolymer of propylene and at least one comonomer selected from ethylene and C₄-C₂₀ alpha-olefins, wherein the propylene copolymer has a propylene content of at least about 80 wt % and has a melting point of greater than about 115° C.

### BRIEF DESCRIPTION OF DRAWINGS

FIG. 1 to FIG. 5 show exemplary layer structures of the inventive films.

### DETAILED DESCRIPTION

Disclosed herein are films comprising a first layer, A (“layer A”), and at least one of a second layer, B (“layer B”) and, alternatively, a third layer, C (“layer C”). The layer A can comprise and/or be formed from a first layer composition comprising a propylene polymer and a hydrocarbon resin, wherein the propylene polymer is a propylene homopolymer, or a copolymer of propylene having at least one comonomer selected from ethylene and C₄-C₂₀ alpha-olefins, wherein the copolymer has a propylene content of at least 80 wt % and has a melting point of greater than 115° C., and wherein the hydrocarbon resin is selected from the group consisting of: an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and a combination thereof.

The layer B can comprise and/or be formed from a second layer composition comprising a copolymer of propylene and at least one comonomer selected from ethylene and C₄-C₂₀ alpha-olefins, wherein the propylene copolymer has a propylene content of at least 80 wt % and has a melting point of greater than 115° C. Preferably, the propylene copolymer in layer B is a random copolymer of propylene.

The layer B may further comprise a hydrocarbon resin, which is selected from the group consisting of: an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and a combination thereof.

The layer C can comprise and/or be formed from a third layer composition comprising a propylene-based elastomer, wherein the propylene-based elastomer comprises propylene and at least one comonomer selected from ethylene and C₄-C₂₀ alpha-olefins, has a propylene content of at least 75 wt %, an mm triad tacticity of greater than 75%, a melting point of less than 115° C., and a heat of fusion of less than 65 J/g.

The present invention surprisingly finds that addition of a hydrocarbon resin in a core layer of films can significantly reduce water vapor, oxygen, nitrogen, and aroma permeation. Without wishing to be bound by theory, for instance, it is believed that the addition of the hydrocarbon resin with a cast polypropylene (CPP) film structure may “lock” the amorphous phase to some degree and prevent it from swelling under the action of the aroma molecules.

### Definitions

As used herein, unless specified otherwise, the term “copolymer(s)” refers to polymers formed by the polymerization of at least two different monomers. For example, the term “copolymer” includes the copolymerization reaction product of propylene and an alpha-olefin, such as ethylene, 1-hexene. However, the term “copolymer” is also inclusive of, for example, the copolymerization of a mixture of ethylene, propylene, 1-hexene, and 1-octene.

As used herein, when a polymer is referred to as “comprising a monomer,” the monomer is present in the polymer in the polymerized form of the monomer or in the derivative form of the monomer.

As used herein, “thermoplastic” includes only those thermoplastic materials that have not been functionalized or substantially altered from their original chemical composition. For example, as used herein, propylene polymer, propylene ethylene copolymers, propylene alpha-olefin copolymers, polyethylene and polystyrene are thermoplastics. However, maleated polyolefins are not within the meaning of thermoplastic as used herein.

Unless otherwise specified, the term “elastomer”, as used herein, refers to any polymer or composition of polymers consistent with the ASTM D1566 definition.

For purposes of this invention and the claims thereto, a “nucleating agent” or “nucleator” is a molecule having a molecular weight of less than 1,000 g/mole that decreases the crystallization time of thermoplastic materials, examples of which include metal salts or organic acids, sodium benzoate, and other compounds known in the art. For purposes of the invention, a “clarifying agent” is a nucleating agent that is soluble in the melt phase of the thermoplastic materials.

As used herein, weight percent (“wt %”), unless noted otherwise, means a percent by weight of a particular component based on the total weight of the mixture containing the component. For example, if a mixture contains three pounds of sand and one pound of sugar, then the sand comprises 75 wt % of the mixture and the sugar 25 wt %.

As used herein, an “unoriented film” refers to a film not drawn or stretched intensively in MD or TD. For example, unoriented films of the invention are preferably stretched at ratio of less than 10, preferably less than 5, and ideally less than 2 in both MD and TD. Preferred unoriented films of the invention include blown films, cast films, and laminated films, ideally cast films.

### Propylene Homopolymers

The inventive films generally comprise at least one layer, e.g., the layer A, which comprises and/or is formed from a composition comprising a propylene polymer and a hydrocarbon resin, wherein the propylene polymer can be a propylene homopolymer. Also, as described herein, the term “propylene homopolymer” and “homopolypropylene” is interchangeable.

Preferably, the homopolypropylene has a melt flow rate (MFR) (ASTM D 1238, 230° C., 2.16 kg) in the range from 0.1 dg/min to 500 dg/min, or from 0.5 dg/min to 200 dg/min, or from 0.5 dg/min to 100 dg/min, or from 1 dg/min to 50 dg/min, or from and from 1.5 dg/min to 20 dg/min, or from 2 dg/min to 10 dg/min. Preferably, the homopolypropylene has a 1% secant flexural modulus ranging from 100 MPa to 2300 MPa, preferably 300 MPa to 2100 MPa, and more preferably from 500 MPa to 2000 MPa. Preferably, the homopolypropylene has a molecular weight distribution (Mw/Mn) of up to 40, preferably ranging from 1.5 to 10, or from 1.8 to 7, or from 1.9 to 5, or from 2.0 to 4.

The propylene homopolymers useful in the present invention may have some level of isotacticity. Thus, in any embodiment, the propylene homopolymer may comprise isotactic polypropylene. As used herein, “isotactic” is defined as having at least 60% isotactic pentads according to analysis by ¹³C-NMR. Alternatively, the propylene homopolymer may include atactic sequences or syndiotactic sequences. For example, a suitable homopolypropylene can have at least 85% syndiotacticity, and alternatively at least 90% syndiotacticity. As used herein, “syndiotactic” is defined as having at least 60% syndiotactic pentads according to analysis by ¹³C-NMR. Atactic homopolypropylene is defined to be less than 10% isotactic or syndiotactic pentads. Preferably, homopolypropylene has at least 85% isotacticity, more preferably at least 90% isotacticity. Suitable isotactic polypropylene has a melt temperature (Tₘ) ranging from a low of about 130° C., or about 140° C., 150° C., or 160° C. to a high of about 160° C., 170° C., or 175° C., preferably from 150° C. to 170° C. The crystallization temperature (T_{c}) of the isotactic polypropylene preferably ranges from a low of about 95° C., 100° C., or 105° C. to a high of about 110° C., 120° C. or 130° C., such as 100° C. to 120° C. Furthermore, the isotactic polypropylene preferably has a crystallinity of at least 25 percent. Generally, the isotactic polypropylene has a melt flow rate of less than about 10 dg/min, often less than about 5 dg/min, and often less than about 3 dg/min. Often, the isotactic polypropylene has a melt flow rate ranging from about 2 dg/min to about 5 dg/min A preferred isotactic polypropylene has a heat of fusion of greater than 75 J/g, or greater than 80 J/g, or greater than 90 J/g to a high of about 150 J/g, such as from about 80 J/g to about 120 J/g. In any embodiment, the isotactic polypropylene may have a density of from about 0.85 g/cc to about 0.93 g/cc. Preferably, the isotactic polypropylene has a density of from about 0.88 g/cc to about 0.92 g/cc, more preferably from about 0.90 g/cc to about 0.91 g/cc.

An illustrative isotactic polypropylene has a weight average molecular weight (Mw) from about 200,000 to about 600,000 g/mole, and a number average molecular weight (Mn) from about 80,000 to about 200,000 g/mole. A more preferable isotactic polypropylene has an Mw from about 300,000 to about 500,000 g/mole, and a Mn from about 90,000 to about 150,000 g/mole. In any embodiment, the isotactic polypropylene may have an MWD within a range having a low of 1.5, 1.8, or 2.0 and a high of 4.5, 5, 10, 20, or 40, preferably from 1.5 to 10.

In one embodiment, the propylene homopolymer has one or more of the following properties: a melt flow rate MFR in the range of from 1.5 dg/min to 20 dg/min, as determined by ASTM D 1238, 230° C., 2.16 kg; a molecular weight distribution Mw/Mn ranging from 1.9 to 5, as determined by GPC; a 1% secant flexural modulus ranging from 500 MPa to 2000 MPa.

Examples of particularly suitable propylene homopolymers include homopolypropylenes commercially available from ExxonMobil Chemical Company under the names of PP4712, and PP4612, from Total Petrochemical under the names of 3371, 3270, 3576X.

### Propylene Copolymers

Suitable propylene copolymers useful in the first layer, A, and/or second layer, B, of the inventive films may be copolymers of propylene and at least one comonomer selected from ethylene and C₄-C₂₀ alpha-olefins.

Preferably, the polypropylene copolymers have a propylene content in an amount greater than about 80 wt %, ideally greater than about 90 wt %, such as from about 93 wt % to about 99.5 wt %, and a comonomer content in an amount ranging from a low of about 0.1, 0.25, 0.5, 1, 2, 3, 4, or 6 wt % to a high of about 1, 3, 5, 7, 8, 9, 15, or 20 wt %, such as from about 0.5 wt % to about 7 wt % based on the weight of the copolymer.

Suitable comonomer(s) can be selected from the group consisting of ethylene and C₄ to C₂₀ linear, branched or cyclic monomers, preferably C₄ to C₁₂ linear or branched alpha-olefins. Suitable comonomers may be present at up to 20 wt %, preferably from 0 to 20 wt %, more preferably from 0.1 to 10 wt %, more preferably from 0.5 to 8 wt % by weight of the propylene-based copolymer.

Preferred linear alpha-olefins useful as comonomers include C₃ to C₈ alpha-olefins, more preferably 1-butene, 1-hexene, and 1-octene, even more preferably 1-butene. Preferred branched alpha-olefins include 4-methyl-1-pentene, 3-methyl-1-pentene, and 3,5,5-trimethyl-1-hexene, 5-ethyl-1-nonene.

Optionally, aromatic-group-containing comonomers, non-aromatic cyclic group containing comonomers, or diolefin comonomers can be comprised in the propylene polymers. These comonomers can contain up to 30 carbon atoms, e.g., from 4 to 20 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions. Often, one or more dienes are present in the propylene-based copolymer at up to 10 wt %, preferably from 0.1 to 5.0 wt %, more preferably from 0.1 to 3 wt % based upon the total weight of the copolymer.

Preferably, the polypropylene copolymer can be selected from random copolymers (RCP), block copolymers, impact copolymers (ICP) (e.g., an intimate blend of polypropylene homopolymer and an ethylene-propylene elastomer, also known in the art as heterophasic copolymers), and terpolymers. Preferred RCPs include single phase polypropylene copolymers having up to about 9 wt %, preferably about 2 wt % to about 8 wt %, of an alpha olefin comonomer, preferably ethylene.

Preferably, useful propylene copolymers have a weight average molecular weight greater than 8,000 g/mol, alternatively greater than 10,000 g/mol, alternatively greater than 12,000 g/mol, and alternatively than 20,000 g/mol. Preferably, useful propylene copolymers have a weight average molecular weight less than 1,000,000 g/mol, and alternatively less than 800,000. A desirable propylene-based copolymer may comprise any upper molecular weight limit with any lower molecular weight limit described herein.

Useful propylene copolymers have an Mw/Mn ranging from 1.5 to 10, preferably from 1.6 to 7, more preferably from 1.7 to 5, and most preferably from 1.8 to 4. Often, suitable propylene-based copolymers have a 1% secant flexural modulus ranging from 100 MPa to 2300 MPa, preferably from 200 MPa to 2100 MPa, and more preferably from 300 MPa to 2000 MPa. Often, suitable propylene-based polymers have an MFR ranging from 0.1 dg/min to 2500 dg/min, preferably from 0.3 dg/min to 500 dg/min.

Often, the propylene copolymers are or comprise a “tailored crystallinity resin” (“TCR”). Suitable TCRs include any modified polypropylene comprising an in situ reactor blend of a higher molecular weight propylene/ethylene random copolymer and a lower molecular weight substantially isotactic homopolypropylene, such as those described in U.S. Pat. No. 4,950,720, incorporated by reference as if fully disclosed herein.

Often, the propylene copolymers useful in the invention can be nucleated with one or more nucleating agents prior to the use in the present film, e.g., prior to incorporation in the film and/or prior to the addition of the hydrocarbon resin. Alternatively, the polypropylene can be non-nucleated, i.e., nucleating agents are absent. In any embodiment, suitable nucleating agents may be selected from the group consisting of sodium benzoate, talc, glycerol alkoxide salts, cyclic carboxylic acid salts, bicyclic carboxylic acid salts, glycerolates, and hexahydrophtalic acid salts. Nucleating agents include HYPERFORM™ additives, such as HPN-68, HPN-68L, HPN-20, HPN-20E, MILLAD™ additives (e.g., MILLAD™ 3988) (Milliken Chemicals, Spartanburg, S.C.) and organophosphates such as NA-11 and NA-21 (Amfine Chemicals, Allendale, N.J.). In any embodiment, suitable nucleating agents may comprise at least one bicyclic carboxylic acid salt. In any embodiment, suitable nucleating agents may comprise bicycloheptane dicarboxylic acid, disodium salt such as bicyclo [2.2.1] heptane dicarboxylate. In any embodiment, suitable nucleating agents may be a blend of components comprising bicyclo [2.2.1] heptane dicarboxylate, disodium salt, 13-docosenamide, and amorphous silicon dioxide. In any embodiment, suitable nucleating agents may be cyclohexanedicarboxylic acid, calcium salt or a blend of cyclohexanedicarboxylic acid, calcium salt, and zinc stearate. In any embodiment, suitable nucleating agents include clarifying agents.

Illustrative polymerization methods to make polypropylene copolymers include, but are not limited to, slurry, bulk phase, solution phase, and any combination thereof. Any catalyst system appropriate for the polymerization of polyolefins may be used, such as Ziegler-Natta-type catalysts, metallocene-type catalysts, or combinations thereof. Such catalysts are well known in the art, and are described in, for example, ZIEGLER CATALYSTS (Gerhard Fink, Rolf Müllhaupt and Hans H. Brintzinger, eds., Springer-Verlag 1995); Resconi et al., Selectivity in Propene Polymerization with Metallocene Catalysts, 100 CHEM. REV. 1253-1345 (2000); and I, II METALLOCENE-BASED POLYOLEFINS (Wiley & Sons 2000).

Preferably the propylene copolymers are made by the catalysts, activators and processes described in U.S. Pat. Nos. 6,342,566, 6,384,142, WO 03/040201, WO 97/19991 and U.S. Pat. No. 5,741,563. Impact copolymers may be prepared by the process described in U.S. Pat. Nos. 6,342,566 and 6,384,142.

Examples of particularly suitable propylene copolymers include random copolymers of polypropylene commercially available from ExxonMobil Chemical Company under the names of PP9513; from INEOS Olefins & Polymers under the name of ELTEX™ P KS400, from Basell under the name of Adsyl™ 6 C₃₀F, and from Borealis under the name of BorPURE™ RD208CF; and terpolymers of propylene such as commercially available from INEOS Olefins & Polymer under the names of ELTEX™ P KS351.

### Hydrocarbon Resins

The inventive films generally comprise at least one layer, e.g., the A layer, that comprises and/or is formed from a polymer composition comprising a hydrocarbon resin.

Suitable hydrocarbon resins include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The hydrocarbon resins may be polar or apolar.

In any embodiment, suitable hydrocarbon resins may comprise one or more hydrocarbon resins produced by the thermal polymerization of cyclopentadiene (CPD) or substituted CPD, which may further include aliphatic or aromatic monomers as described later. The hydrocarbon resin may be a non-aromatic resin or an aromatic resin. The hydrocarbon resin may have an aromatic content between 0 wt % and 60 wt %, or between 1 wt % and 60 wt %, or between 1 wt % and 40 wt %, or between 1 wt % and 20 wt %, or between 10 wt % and 20 wt %. Alternatively or additionally, the hydrocarbon resin may have an aromatic content between 15 wt % and 20 wt %, or between 1 wt % and 10 wt %, or between 5 wt % and 10 wt %. Preferred aromatics that may be in the hydrocarbon resin include one or more of styrene, indene, derivatives of styrene, and derivatives of indene. Particularly preferred aromatic olefins include styrene, alpha-methylstyrene, beta-methylstyrene, indene, and methylindenes, and vinyl toluenes. Styrenic components include styrene, derivatives of styrene, and substituted styrenes. In general, styrenic components do not include fused-rings, such as indenics.

In any embodiment, suitable hydrocarbon resins may comprise hydrocarbon resins produced by the catalytic (cationic) polymerization of linear dienes. Such monomers are primarily derived from Steam Cracked Naphtha (SCN) and include C₅ dienes such as piperylene (also known as 1,3-pentadiene). Polymerizable aromatic monomers can also be used to produce resins and may be relatively pure, e.g., styrene, -methyl styrene, or from a C₉-aromatic SCN stream. Such aromatic monomers can be used alone or in combination with the linear dienes previously described. “Natural” monomers can also be used to produce resins, e.g., terpenes such as alpha-pinene or beta-carene, either used alone or in high or low concentrations with other polymerizable monomers. Typical catalysts used to make these resins are AlCl₃ and BF₃, either alone or complexed. Mono-olefin modifiers such as 2-methyl, 2-butene may also be used to control the MWD of the final resin. The final resin may be partially or totally hydrogenated.

In any embodiment, suitable hydrocarbon resins may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons, such as from 20% to 50% olefinic protons. As used herein, “substantially hydrogenated” means that the material contains less than 5% olefinic protons, or less than 4% olefinic protons, or less than 3% olefinic protons, or less than 2% olefinic protons, such as from 1% to 5% olefinic protons. The degree of hydrogenation is typically conducted so as to minimize and avoid hydrogenation of the aromatic bonds.

In any embodiment, suitable hydrocarbon resins may comprise one or more oligomers such as dimers, trimers, tetramers, pentamers, and hexamers. The oligomers may be derived from a petroleum distillate boiling in the range of 30° C. to 210° C. The oligomers may be derived from any suitable process and are often derived as a byproduct of resin polymerization. Suitable oligomer streams may have an Mn between 130 and 500, or between 130 and 410, or between 130 and 350, or between 130 and 270, or between 200 and 350, or between 200 and 320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

Preferably, suitable hydrocarbon resins comprises a dicyclopentadiene, cyclopentadiene, and methylcyclopentadiene derived content of about 60 wt % to about 100 wt % of the total weight of the hydrocarbon resin. In any embodiment, suitable hydrocarbon resins may have a dicyclopentadiene, cyclopentadiene, and methylcyclopentadiene derived content of about 70 wt % to about 95 wt %, or about 80 wt % to about 90 wt %, or about 95 wt % to about 99 wt % of the total weight of the hydrocarbon resin. Preferably, the hydrocarbon resin may be a hydrocarbon resin that includes, in predominant part, dicyclopentadiene derived units. The term “dicyclopentadiene derived units”, “dicyclopentadiene derived content”, and the like refers to the dicyclopentadiene monomer used to form the polymer, i.e., the unreacted chemical compound in the form prior to polymerization, and can also refer to the monomer after it has been incorporated into the polymer, which by virtue of the polymerization reaction typically has fewer hydrogen atoms than it does prior to the polymerization reaction.

In any embodiment, suitable hydrocarbon resins may have a dicyclopentadiene derived content of about 50 wt % to about 100 wt % of the total weight of the hydrocarbon resin, more preferably about 60 wt % to about 100 wt % of the total weight of the hydrocarbon resin, even more preferably about 70 wt % to about 100 wt % of the total weight of the hydrocarbon resin. Accordingly, in any embodiment, suitable hydrocarbon resins may have a dicyclopentadiene derived content of about 50% or more, or about 60% or more, or about 70% or more, or about 75% or more, or about 90% or more, or about 95% or more, or about 99% or more of the total weight of the hydrocarbon resin.

Suitable hydrocarbon resins may include up to 5 wt % indenic components, or up to 10 wt % indenic components. Indenic components include indene and derivatives of indene. Often, the hydrocarbon resin includes up to 15 wt % indenic components. Alternatively, the hydrocarbon resin is substantially free of indenic components.

Preferred hydrocarbon resins have a melt viscosity of from 300 to 800 centipoise (cPs) at 160° C., or more preferably of from 350 to 650 cPs at 160° C. Preferably, the melt viscosity of the hydrocarbon resin is from 375 to 615 cPs at 160° C., or from 475 to 600 cPs at 160° C. The melt viscosity may be measured by a Brookfield viscometer with a type “J” spindle according to ASTM D 6267.

Suitable hydrocarbon resins have an Mw greater than about 600 g/mole or greater than about 1000 g/mole. In any embodiment, the hydrocarbon resin may have an Mw of from about 600 to about 1400 g/mole, or from about 800 g/mole to about 1200 g/mole. Preferred hydrocarbon resins have a weight average molecular weight of from about 800 to about 1000 g/mole. Suitable hydrocarbon resins may have an Mn of from about 300 to about 800 g/mole, or from about 400 to about 700 g/mole, or more preferably from about 500 to about 600 g/mole. Suitable hydrocarbon resins may have an Mz of from about 1250 to about 3000 g/mole, or more preferably from about 1500 to about 2500 g/mole. In any embodiment, suitable hydrocarbon resins may have an Mw/Mn of 4 or less, preferably from 1.3 to 1.7.

Preferred hydrocarbon resins have a glass transition temperature (Tg) of from about 30° C. to about 200° C., or from about 0° C. to about 150° C., or from about 50° C. to about 160° C., or from about 50° C. to about 150° C., or from about 50° C. to about 140° C., or from about 80° C. to about 100° C., or from about 85° C. to about 95° C., or from about 40° C. to about 60° C., or from about 45° C. to about 65° C. Preferably, suitable hydrocarbon resins have a Tg from about 60° C. to about 90° C.

Preferably, the hydrocarbon resin has a total dicyclopentadiene, cyclopentadiene, and methylcyclopentadiene derived content of from about 60 wt % to about 100 wt % of the total weight of the hydrocarbon resin and wherein the hydrocarbon resin has a weight average molecular weight of from about 600 g/mole to about 1400 g/mole.

Specific examples of commercially available hydrocarbon resins include Oppera™ PR 100, 100A, 101, 102, 103, 104, 105, 106, 111, 112, 115, and 120 materials, and Oppera™ PR 131 hydrocarbon resins, all available from ExxonMobil Chemical Company, ARKON™ M90, M100, M115 and M135 and SUPER ESTER™ rosin esters available from Arakawa Chemical Company of Japan, SYLVARES™ phenol modified styrene- and methyl styrene resins, styrenated terpene resins, ZONATAC terpene-aromatic resins, and terpene phenolic resins available from Arizona Chemical Company, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTACT™ C5/C9 resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C₅ resins, C₅/C₉ resins, and acid modified C₅/C₉ resins available from Nippon Zeon of Japan, and LX™ mixed aromatic/cycloaliphatic resins available from Neville Chemical Company, CLEARON hydrogenated terpene aromatic resins available from Yasuhara. The preceding examples are illustrative only and by no means limiting.

These commercial compounds generally have a Ring and Ball softening point (measured according to ASTM E-28 (Revision 1996), with a heating and cooling rate of 10° C./min) of about 10° C. to about 200° C., more preferably about 50° C. to about 180° C., more preferably about 80° C. to about 175° C., more preferably about 100° C. to about 160° C., more preferably about 110° C. to about 150° C., and more preferably about 125° C. to about 140° C., wherein any upper limit and any lower limit of softening point may be combined for a preferred softening point range.

The hydrocarbon resin of the present invention can be blended with the propylene polymer to produce the polymer composition of the A layer of the film. The hydrocarbon resin can also be pre-blended with a propylene polymer or other polymers that are miscible with the propylene polymers as described herein, and then blended with the propylene polymer to form the polymer composition. Often, the pre-blend can comprise the hydrocarbon resin ranging from a lower limit of about 1%, 3%, 5%, 10%, 15%, 20%, 30%, 40%, 50%, 60%, 70%, or 80% to an upper limit of about 90%, 80%, 70%, 60%, 50% or 40%, by weight of the pre-blend, such as from 1% to 90%, or from 1% to 80%, or from 1% to 70%, or from 1% to 60%, or from 5% to 60%, or from 5% to 50%, or from 5% to 40%, or from 10% to 50%, or from 10% to 40%, or from 10% to 30% by weight based on the total weight of the blend, or any ranges between two values as described above so long as the lower limit value is less than the upper limit value.

### Propylene-Based Elastomers

The inventive films may further comprise at least one layer, e.g., the layer C, which comprises and/or is formed from a polymer composition comprising a propylene-based elastomer. As used herein, the term “propylene-based elastomer” means a polymer having a melt flow rate in the range of 0.5 to 50 dg/min., a heat of fusion of less than 75 J/g and comprising 65 to 99 wt % of polymer units derived from propylene and 1 to 35 wt % of polymer units derived from ethylene, a C₄ to C₂₀ alpha-olefin comonomer, a diene, or mixtures thereof, based upon total weight of the propylene-based elastomer.

Particularly suitable propylene-based elastomers include copolymers of propylene and at least one comonomer selected from ethylene and C₄-C₁₀ alpha-olefins. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

Preferably, the propylene content of the propylene-based elastomer may range from an upper limit of about 99 wt %, about 97 wt %, about 95 wt %, about 94 wt %, about 92 wt %, about 90 wt %, or about 85 wt %, to a lower limit of about 75 wt %, about 80 wt %, about 82 wt %, about 85 wt %, or about 90 wt %, for example, from about 75 wt % to about 99%, from about 80 wt % to about 99 wt %, or from about 90 wt % to about 97 wt %, based on the weight of the propylene-based elastomer. Preferably, the comonomer content of the propylene-based elastomer may range from about 1 to about 25 wt %, or about 3 to about 25 wt %, or about 3 to about 20 wt %, or about 3 to about 18 wt %, or from about 3 wt % to about 11 wt %, of the propylene-based elastomer. The comonomer content may be adjusted so that the propylene-based elastomer has a heat of fusion of less than about 80 J/g, a melting point of about 115° C. or less, and a crystallinity of about 2% to about 65% of the crystallinity of isotactic polypropylene, and a fractional melt mass-flow rate of about 0.5 to about 20 g/min.

Preferably, the comonomer is ethylene, 1-hexene, or 1-octene, with ethylene being most preferred. Where the propylene-based elastomer comprises ethylene-derived units, the propylene-based elastomer may comprise an ethylene content from about 3 to about 25 wt %, or about 4 to about 20 wt %, or about 9 to about 18 wt %. Often, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt mass-flow rate of the propylene-based elastomer, or in an amount such that any other comonomer is intentionally added to the polymerization process.

Often, the propylene-based elastomer may comprise more than one comonomer. Preferred propylene-based elastomers having more than one comonomer include propylene-ethylene-octene, propylene-ethylene-hexene, and propylene-ethylene-butene polymers. Where more than one comonomer is present, a single comonomer may be present at a concentration of less than about 5 wt % of the propylene-based elastomer, but the total comonomer content of the propylene-based elastomer is generally about 5 wt % or greater.

The propylene-based elastomer may have an mm triad tacticity index as measured by ¹³C NMR, of at least about 75%, at least about 80%, at least about 82%, at least about 85%, or at least about 90%. Preferably, the propylene-based elastomer has an mm triad tacticity of about 75 to about 99%, or about 80 to about 99%. In some embodiments, the propylene-based elastomer may have an mm triad tacticity of about 75 to 97%. The “mm triad tacticity index” of a polymer is a measure of the relative isotacticity of a sequence of three adjacent propylene units connected in a head-to-tail configuration. More specifically, in the present invention, the mm triad tacticity index (also referred to as the “mm Fraction”) of a polypropylene homopolymer or copolymer is expressed as the ratio of the number of units of meso tacticity to all of the propylene triads in the copolymer:

$$mm Fraction = \frac{PPP ( mm )}{PPP ( mm ) + PPP ( mr ) + PPP ( rr )}$$

where PPP(mm), PPP(mr) and PPP(rr) denote peak areas derived from the methyl groups of the second units in the possible triad configurations for three head-to-tail propylene units, shown below in Fischer projection diagrams:

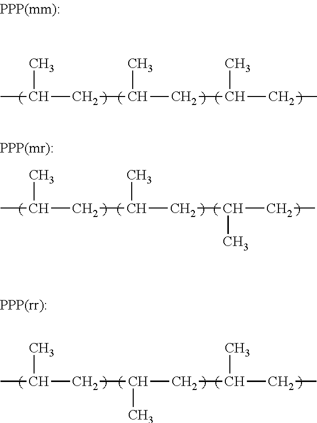

The calculation of the mm fraction of a propylene polymer is described in U.S. Pat. No. 5,504,172 (homopolymer: column 25, line 49 to column 27, line 26; copolymer: column 28, line 38 to column 29, line 67). For further information on how the mm triad tacticity can be determined from a ¹³C-NMR spectrum, see 1) J. A. Ewen, CATALYTIC POLYMERIZATION OF OLEFINS: PROCEEDINGS OF THE INTERNATIONAL SYMPOSIUM ON FUTURE ASPECTS OF OLEFIN POLYMERIZATION, T. Keii and K. Soga, Eds. (Elsevier, 1986), pp. 271-292; and 2) U.S. Patent Application US2004/054086 (paragraphs [0043] to [0054]).

The propylene-based elastomer generally has a heat of fusion of about 65 J/g or less, or about 60 J/g or less, or about 50 J/g or less, or about 40 J/g or less. The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, or 65 J/g.

The propylene-based elastomer may have a percent crystallinity of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22%, of the crystallinity of isotactic polypropylene.

In any embodiment, the propylene-based elastomer may have a tacticity index [m/r] from a lower limit of about 4, or about 6, to an upper limit of about 8, or about 10, or about 12. Often, the propylene-based elastomer has an isotacticity index greater than 0%, or within the range having an upper limit of about 50%, or about 25%, and a lower limit of about 3%, or about 10%. The tacticity index is calculated as defined in H. N. Cheng, Macromolecules, 17, 1950 (1984). When [m/r] is O to less than 1.0, the polymer is generally described as syndiotactic, when [m/r] is 1.0, the polymer is atactic, and when [m/r] is greater than 1.0, the polymer is generally described as isotactic.

Often, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a Tₘ of about 115° C. or less, about 110° C. or less, about 105° C. or less, about 100° C. or less, about 90° C. or less, about 80° C. or less, or about 70° C. or less. Often, the propylene-based elastomer has a Tₘ of about 25 to about 115° C., or about 40 to about 110° C., or about 60 to about 105° C.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt mass-flow rate (MFR), as measured based on ASTM D1238, 2.16 kg at 230° C., of at least about 0.5 g/10 min. In some embodiments, the propylene-based elastomer may have a fractional MFR of about 0.5 to about 50 g/10 min, or about 2 to about 18 g/10 min. The propylene-based elastomer may have an Elongation at Break of less than about 2000%, less than about 1800%, less than about 1500%, or less than about 1000%, as measured based on ASTM D638.

The propylene-based elastomer may have an Mw of about 5,000 to about 5,000,000 g/mol, or about 10,000 to about 1,000,000 g/mol, or about 50,000 to about 400,000 g/mol. The propylene-based elastomer may have an Mn of about 2,500 to about 250,000 g/mol, or about 10,000 to about 250,000 g/mol, or about 25,000 to about 250,000 g/mol. The propylene-based elastomer may have a an Mz of about 10,000 to about 7,000,000 g/mol, or about 80,000 to about 700,000 g/mol, or about 100,000 to about 500,000 g/mol. The propylene-based elastomer may have an Mw/Mn of about 1.5 to about 20, or about 1.5 to about 15, or about 1.5 to about 5, or about 1.8 to about 3, or about 1.8 to about 2.5.

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

### Additives

Optionally, additives may be present in the polymer composition of any layer of the films that are known in the art for modifying the polymer composition to provide particular physical characteristics or effects. The use of appropriate additives is well within the skill of one in the art. Examples of such additives include slip additive, antiblocking additive (e.g., silica), colored pigments, UV stabilizers, antioxidants, light stabilizers, flame retardants, antistatic agents, biocides, viscosity-breaking agents, impact modifiers, plasticizers, fillers, reinforcing agents, lubricants, mold release agents, blowing agents, pearlizers, and the like. Such additives may comprise from about 0.01% to about 10% by weight based on the total weight of the polymer composition of the layer. Alternatively, additives may be absent or substantially absent from the polymer composition of any layer. For instance, additives may comprise less than 1.0%, or less than 0.5%, or less than 0.1% by weight based on the total weight of the polymer composition of the layer.

Preferably, a third layer of the inventive films comprises a slip additive and/or antiblocking additive in an amount of from 0.01 to 10 wt % by the weight of the layer.

### Layer Compositions

Generally, the films of the present invention are comprised of at least one layer A in combination with at least one layer B and/or at least one layer C. Preferably, the films are comprised of at least one layer A, at least one layer B, and optionally at least one layer C. The layer A can comprise (or consist of, or consist essentially of) and/or be formed from a first layer composition comprising (or consisting of, or consisting essentially of) a propylene polymer and a hydrocarbon resin. The layer B can comprise (or consist of, or consist essentially of) and/or be formed from a second layer composition comprising (or consisting of, or consisting essentially of) a propylene copolymer. Additionally or alternatively, hydrocarbon resin and/or propylene-based elastomer is absent or substantially absent in the second layer composition and/or the layer B. For example, the second layer composition and/or the layer B can comprise less than 30 wt %, or less than 20 wt %, or less than 10 wt %, or less than 5 wt %, or less than 1 wt % of hydrocarbon resin and/or propylene-based elastomer. When the film comprises two or more layers B, the propylene copolymer in each layer B can be the same or different from one another. Further, two or more propylene copolymers can be used in each second layer composition.

The layer C can comprise (or consist of, or consist essentially of) and/or be formed from a third layer composition comprising (or consisting of, or consisting essentially of) a propylene-based elastomer. Additionally or alternatively, hydrocarbon resin is absent or substantially absent in the third layer composition and/or the layer C. For example, the third layer composition and/or the layer C can comprise less than 30 wt %, or less than 20 wt %, or less than 10 wt %, or less than 5 wt %, or less than 1 wt % of a hydrocarbon resin. When the film comprises two or more layers C, the propylene-based elastomer in each layer C can be the same or different from one another. Further, two or more propylene-based elastomers can be combined and used in each third layer composition.

In any embodiment, the layer A and/or the first layer composition can comprise at least about 40 wt % of the propylene polymer and not greater than about 60 wt % of the hydrocarbon resin. For example, the layer A and/or the first layer composition can comprise from a lower limit of about 40 wt %, 45 wt %, 50 wt %, 60 wt %, or 65 wt %, to an upper limit of from about 99 wt %, 95 wt %, 90 wt %, 85 wt %, 80 wt %, 75 wt %, or 70 wt %, of the propylene homopolymer, based on total weight of the layer A and/or the first layer composition. Preferably, the amount of the propylene polymer(s) in the layer A and/or the first layer composition of the film is from about 40 wt % to about 99 wt %, from about 50 wt % to about 95 wt %, from about 60 wt % to about 90 wt %, from about 70 wt % to about 80 wt %, or any ranges between the above described lower limit and upper limit values so long as the lower limit value is less than the upper limit value. The layer A and/or the first layer composition can comprise from a lower limit of about 1 wt %, 5 wt %, 10 wt %, 20 wt %, 30 wt %, to an upper limit of from 60 wt %, 50 wt %, 45 wt %, or 40 wt % of the hydrocarbon resin(s), based on the total weight of the layer A and/or the first layer composition. Preferably, the amount of the hydrocarbon resin(s) in the layer A and/or the first layer composition of the film is from about 1 to about 60 wt %, from about 5 to about 50 wt %, from about 10 wt % to about 40 wt %, from about 10 wt % to about 30 wt %, or any ranges between the above described lower limit and upper limit values so long as the lower limit value is less than the upper limit value.

In any embodiment, the layer B and/or the second layer composition can comprise from at least 20 wt %, 30 wt %, 40 wt %, 50 wt %, 60 wt %, 70 wt %, 80 wt %, 90 wt %, or 100 wt % of the propylene copolymer(s) described herein. Preferably, the layer B may consist of 100 wt % of the propylene homopolymer(s).

In any embodiment, the layer C and/or the third layer composition can comprise from at least about 10 wt %, 20 wt %, 30 wt %, 40 wt %, 50 wt %, 60 wt %, 70 wt %, 80 wt %, 90 wt %, or 100 wt % of the propylene-based elastomers by weight of the layer C and/or the third layer composition. Preferably, the layer C may consist of 100 wt % of the propylene-based elastomer(s).

Additives may be optionally present in the layer A, the layer B, and/or the layer C in an amount of less than 10 wt %, or 8 wt %, or 5 wt %, or 3 wt %, or 2 wt %, or 1 wt %, or 0.5 wt %, or 0.1 wt % based on the weight of the layer or the polymer composition used to form the layer. For example, a nucleating agent may often be present in the layer A. Additionally, a slip additive and/or an antiblocking additive may often be present.

### Film Structures

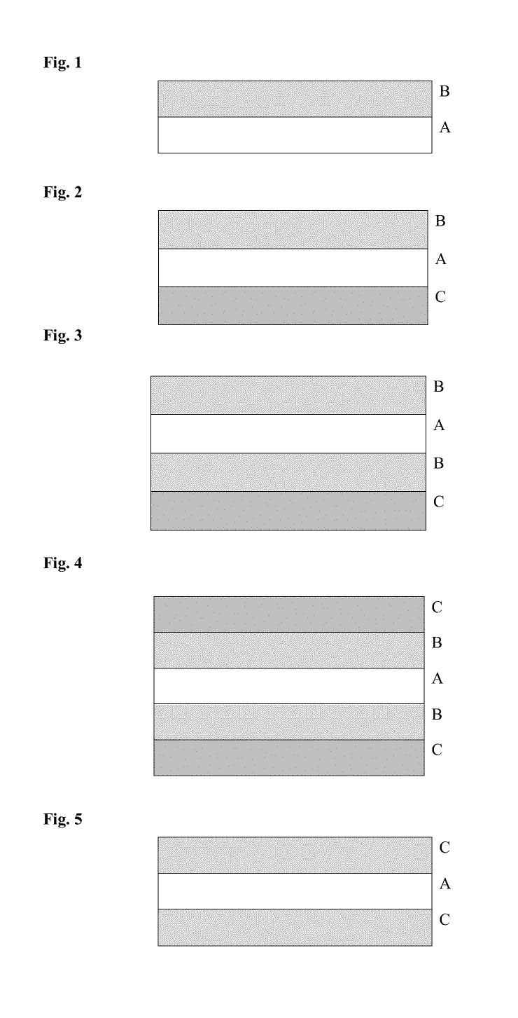

The films of the present invention generally comprise a first layer (layer A) and at least one of a second layer (layer B) and a third layer (Layer C). Preferably, the films comprise a layer A and a layer B, i.e., an A/B lamination as shown in FIG. 1. Preferably, the films comprise a layer A, two layers B each joined on one surface of the layer A, i.e., a B/A/B structure. The two layers B can be the same or different (i.e., B and B′).

Alternatively, the films further comprise at least one third layer (layer C). Preferred lamination structures of the films are described in the following illustrated structures. The invention is not limited to these illustrated structures, and this description is not meant to foreclose other aspects within the broader scope of the invention.

Often, the film comprises an odd number of layers, preferably three layers or five layers.

Preferably, the film may comprise one layer A, one layer B joined on one surface of the layer A, and one layer C joined on the other surface of the layer A, i.e., a B/A/C structure as shown in FIG. 2.

Alternatively, the film may comprise one layer A, two layers B each joined on one surface of the layer A, and a layer C joined on one of the two layers B, i.e., a B/A/B/C structure as shown in FIG. 3. The two layers B can be the same or different (i.e., B and B′).

Alternatively, the film may comprise one layer A, two layers B each joined on one surface of the layer A, and two layers C each joined on one layer B, i.e., a C/B/A/B/C structure as shown in FIG. 4. The two layers B can be the same or different (i.e., B and B′), and the two layers C can be the same or different (i.e., C and C′) as well.

Yet alternatively, the film may comprise one layer A and two layers C joined on the two surfaces of the layer A, i.e., a C/A/C structure as shown in FIG. 5.

Generally, any of the foregoing described film layer(s) may be added to the layer A and/or to the at least one layer B joined on the layer A, depending on the desired film application. For example, the films can comprise other layer lamination structures, such as B/A/C/B, B/A/C/B′, C/B/A/C, C/B/A/C′, B/A/C/B/C′, B/A/C/B′/C, B/A/C/B′/C′, B/A/B/A′/C, B/A/B′/A/C, B/A/B′/A′/C, C/B/A/B′/A′/C′, C/B/A/B/A′/C′, C/B/A/B′/A/C′, C/B/A/B′/A′/C, C/B/A/B′/A′/C′, etc.

The present films can optionally comprise an additional sealing layer(s) (i.e., “layer(s) D”) other than the layer A, the layer B, and the layer C. The additional layers D can comprise and/or be formed from polyolefins and materials other than propylene polymers, such as paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens, and substrates coated with inks, dyes, pigments, and the like. Examples of film structures of D-containing films include B/A/D, B/A/C/D, D/B/A/B′/C, B/A/B′/C/D, D/C/B/A/B′/C′, C/B/A/B′/C′/D, or the like.

Generally, the thickness of the films may range from about 10 to about 200 μm and is mainly determined by the intended use and properties of the film. The present films may be thin, e.g., for packing small or light-weight products, or can be much thicker, e.g., for applications in heavy duty bags. Conveniently, the films described herein have a thickness of from about 10 to about 200 μm, from about 20 to about 150 μm, or from about 30 to about 130 μm.

Preferably, the layer A has a thickness of at least about one third, for example, about one third, about two fifths, about half, about three fifths, about two thirds, about four fifths, or in the range of any combination of the values recited herein, of the total thickness of the film. More preferably, the thickness of the layer A is from 30% to 70% of the total thickness of the film. Alternatively or additionally, the thickness ratio between the layer A and the layer B is about (0.5-5):1, for example, from about 1:1 to about 4:1, such as, about 0.5:1, 1:1, about 1.5:1, about 2:1, about 2.5:1, about 3:1, about 3.5:1, or about 4:1. The thickness of the layer(s) C can be determined based on the actual needs of desired application, for example, the thickness of the layer(s) C can be one fifth, one fourth, two fifths of the total thickness of the film, but usually not more than one half of the total thickness of the film.

### Methods of Making the Films

The films described herein may be formed by any of the conventional techniques known in the art. Illustrative methods include blown extrusion, cast extrusion, and co-extrusion. Therefore, the film herein can be a cast film, a blown film, or a laminated film.

Preferably, the films of the present invention are formed by using cast extrusion techniques, i.e., to form a cast film. For example, the film structure maybe formed by coextruding the core layer together with the heat sealable layer and functional layer through a flat sheet extruder die at a temperature ranging from between about 200° C. to about 270° C., casting the film onto a cooling drum and quenching the film. The chilling temperature of the cooling drum can be controlled by cooling water having a temperature of from about 0° C. to about 40° C.

In one aspect, the present invention provides a use of a composition comprising a propylene polymer and a hydrocarbon resin in a first layer of the film for improving barrier properties of the film as compared to the same film free of the hydrocarbon resin in the first layer. In a preferred embodiment, the composition has improved barrier properties against water vapor, oxygen, nitrogen or aroma.

Preferably, water vapor transmission rate of the inventive films can be reduced at least 5%, 10%, 20%, 30%, 40%, 50%, 60%, 70%, than the same films free of the hydrocarbon resin in the first layer, as measured according to ASTM F1249.

Preferably, oxygen transmission rate of the inventive films can be reduced at least 5%, 10%, 20%, 30%, 40%, 50%, 60%, 70%, than the same films free of the hydrocarbon resin in the first layer, as measured according to the test method disclosed herein.

Preferably, nitrogen transmission rate of the inventive films can be reduced at least 5%, 10%, 20%, 30%, 40%, 50%, 60%, 70%, than the same films free of the hydrocarbon resin in the first layer, as measured according to the test method disclosed herein.

Preferably, aroma permeation of the inventive films can be reduced at least 10%, 20%, 30%, 40%, 50%, 60%, 70%, than the same films free of the hydrocarbon resin in the first layer, as measured according to the test method disclosed herein. The aroma substance is selected from the group consisting of: cis-3-hexenol, isoamylacetate, R+limonene, menthol, citronellol, linalylacetate, diphenyloxide, and a combination thereof.

The films described herein can be used for any purpose, but are particularly suited to packaging, in particular to food packaging applications. Preferably, the present invention provide a packaging film comprising a core layer and a sealing layer laminated on the core layer, wherein the core layer comprises from 70 to 99 wt % of the propylene polymer and from 1 to 30 wt % of the hydrocarbon resin as disclosed herein. The present invention provides a packaging bag, particularly food packaging bag, obtained by forming the packaging film into a bag-like shape, and then heating sealing facing surfaces of the sealing layer.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

### Materials

FC801 (“PP3”) is a homopolypropylene having an MFR (2.16 kg @ 230° C., ASTM D-1238) of 8.0±2.0 dg/min, commercially available from Sinopec, the People Republic of China.

F800E (“PP4”) is a random copolymer of propylene and ethylene having an MFR (2.16 kg @ 230° C., ASTM D-1238) of 8.0±2.5 dg/min, commercially available from Sinopec, the People Republic of China.

COSMOPLENE™ H.7540L (“PP5”) is polypropylene terpolymer product having an MFR (2.16 kg @ 230° C., ASTM D-1238) of 7 dg/min, commercially available from The Polyolefin Company (Singapore) Pte Ltd.

Vistamaxx™ 3588 polymer (“PBE1”) is a propylene-based elastomer having about 4 wt % of ethylene-derived units with the remaining of propylene-derived units, and having a vicat softening temperature 103° C., a density of about 0.889 g/cm³, and an MFR (230° C., 2.16 kg) of about 8.0 dg/min, and is commercially available from ExxonMobil Chemical Company, TX.

Oppera™ PR 100A (“HCR”) resin is an amorphous cyclic olefin oligomer hydrocarbon resin available from ExxonMobil Chemical Company, TX.

MA00930PP (“HMB”) is a masterbatch containing 40 wt % homopolypropylene having an MFR of 3 dg/min (2.16 kg @ 230° C., ASTM D-1238) and 60 wt % of the hydrocarbon resin under tradename Oppera™ PR100N available from ExxonMobil Chemical Company, TX; the masterbatch is commercially available from Constab Polyolefin Additives GmbH, Germany.

POLYBATCH™ SPR6 (“SMB”) is a slip additive commercially available from A. Schulman, OH.

POLYBATCH™ ABPP05 SC MED (“ABMB”) is an antiblocking additive commercially available from A. Schulman, OH.

### Testing Methods

Molecular Weight and Molecular Weight Distribution:

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated (with polystyrene standard), are described in: T. Sun, P. Brant, R. R. Chance, and W. W. Graessley, Macromolecules, Volume 34, Number 19, pp. 6812-6820, 2001. In one or more embodiments, the polymer blend can have a polydispersity index of from about 1.5 to about 6.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hrs. before injecting the first sample. The LS laser is turned on 1 to 1.5 hrs. before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and do/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[K_{O}c/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and K_{O} is the optical constant for the system:

$${K}_{o} = \frac{4 {π}^{2} {{n}^{2} ( dn / dc )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡wᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣMᵢ

since the mole fraction xᵢ is defined as Nᵢ divided by the total number of molecules:

xᵢ=Nᵢ/ΣNᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the following equation:

η_{S}=c[η]+0.3(n[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and c=0.695 for ethylene polymers; k=0.0002288 and α=0.705 for propylene polymers; and k=0.00018 and α=0.7 for butene polymers.

M_{V} is the viscosity-average molecular weight based on molecular weights determined by the LS analysis:

M_{V}≡(ΣcᵢMᵢ^{α}/Σcᵢ)^{1/α}

Melt Temperature, Crystallization Temperature, % Crystallinity, Glass Transition Temperature:

Melting point (Tm), can be determined by differential scanning calorimetry (DSC). The maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak. can be determined by taking 5 to 10 mg of a sample, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the final temperature as Tm. Crystallization temperature (Tc) can be determined by taking 5 to 10 mg of a sample, equilibrating a DSC Standard Cell FC at −90° C., ramping the temperature at a rate of 5-10° C. per minute up to 200° C., maintaining the temperature for 5 minutes, lowering the temperature at a rate of 5-10° C. per minute to −90° C., and recording the final temperature as Tc. Heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The glass transition (Tg) is measured by the test method described herein. 8(+/−1 mg) of the sample was weighed and introduced in an aluminum pan. A cover was placed on the pan and sealed with a press. The sample was conditioned by two heating and one cooling cycle as described. The sample was heated from 25° C. to 80° C. at a rate of 20° C./min followed by a 1 min hold at 80° C. (first heating cycle). The sample was cooled from 80° C. to −100° C. at a rate of 10° C./min followed by 5 minute hold at −100° C. (first cooling cycle). The Tg is measured by again heating the sample from −100° C. to 80° C. at a rate of 20° C./min (second heating cycle). The glass transition temperature reported is the midpoint of step change when heated during the second heating cycle.

Water Vapor Transmission Rate (WVTR) was measured by Permatran W-700, which was manufactured by MOCON used to measure WVTR of films. The films were placed in special permeation cells and stored at 38° C. One side of a film was flushed with a “carrier” gas, which is “dry” or 0% relative humidity (RH). The carrier gas is nitrogen. The other side of the film is provided water vapor, which is 100% RH. The water vapor permeated through the film and was delivered to a sensor by routing the carrier gas from the test cell to the sensor. 2 specimens were prepared per example and masked to 50 cm² and each specimen was gauged 5 points within test area and recorded on the specimen. WVTR was calculated in accordance with the amount of water vapor measured by the sensor.

Oxygen Transmission Rate (OTR) was measured by Ox-Tran model 2/21, which was manufactured by MOCON used to measure OTR of films. The films were placed in special permeation cells and stored at 23±0.5° C. One side of a film was blanket with air (21% O₂). On the other side, a carrier gas (98% nitrogen, 2% hydrogen) can deliver the oxygen molecules to the sensor. 2 specimens were prepared per example and masked to 100 cm², and each specimen is gauged 5 points within test area and recorded on the specimen. OTR was calculated in accordance with the amount of oxygen measured by the sensor.

Nitrogen Transmission Rate (NTR) was measured by manometric method on a GDP-E device from the Brugger Company in Munich. The NTR testing was carried out at 23° C. and 0% relative humidity. The films were mounted in special permeation cells, dividing the cells into 2 chambers. For each measurement, vacuum was first made in the first chamber. Then the second chamber was filled with pure nitrogen gas (N2) and maintained under atmospheric pressure. As a result of the partial pressure difference between the 2 chambers, the nitrogen gas passed through the film. The rate of pressure increase of the permeated nitrogen gas in the first chamber was measured by electronic sensors and was used to determine the NTR. 2 specimens were prepared per example and measured for NTR.

Aroma Permeation was measured by using permeation cells and a gas chromatograph. The films were placed in permeation cells and stored at 40° C. 5 g mixture of different aroma substances listed in Table 1 were diluted in 95 g of polyethylenglycol 400. Table 2 shows the exact amount of each substance in resultant solution. 25 g of the diluted solution were introduced in the lower side of the cells ensuring that the films for testing had no direct contact with the substances. The other side of the cells was rinsed with nitrogen. The nitrogen flow moved the permeated substances out of the cells. The nitrogen stream was analyzed for the substances by using an enrichment unit and gas chromatography with flame ionisation detection (GC/FID). Calibration was performed with injecting known amounts of the substances. Test results of the permeation, calculated in μg/(d·dm²), were collected after 10 days or at maximum (if maximum comes before 10 days) at 40° C., as shown in Table 5. 2 specimens were prepared per example and measured for aroma permeation.

TABLE 1
CHARACTERISTICS OF AROMA SUBSTANCES
USED FOR PERMEATION TEST

| | | | | | | In |
|---|---|---|---|---|---|---|
| | | | | Melting | Boiling | mix- |
| | | Mw | Density | Point | Point | ture |
| Substances | | g/mol | g/mol | ° C. | ° C. | (g) |
| Isoamylacetate | C₇H₁₄O₂ | 130.19 | 0.870 | −79 | 142 | 0.05 |
| d-Limonene | C₁₀H₁₆ | 136.24 | 0.841 | −74 | 178 | 0.05 |
| cis-3-Hexenol | C₆H₁₂O | 100.16 | 0.848 | −61 | 156 | 1.00 |
| Linalylacetate | C₁₂H₁₀O₂ | 196.29 | 0.895 | | 222 | 5.00 |
| Menthol | C₁₀H₂₀O | 156.27 | 0.904 | 44 | 216 | 10.0 |
| Citronellol | C₁₀H₂₀O | 156.27 | 0.859 | | 244 | 10.0 |
| Diphenyloxide | C₁₂H₁₀O | 170.21 | 1.089 | 26 | 287 | 10.0 |

TABLE 2
CONCENTRATION OF AROMA SUBSTANCES USED FOR
PERMEATION TEST

| Substances | Concentration in PEG (ppm) (μg/ml) |
|---|---|
| Isoamylacetate | 69 |
| d-Limonene | 69 |
| cis-3-Hexenol | 1,385 |
| Linalylacetate | 6,925 |
| Menthol | 13,850 |
| Citronellol | 13,850 |
| Diphenyloxide | 13,850 |

### Example 1

Three-layer cast films having a B/A/B′ structure was fabricated in a cast film, where the layer A is 100 wt % PP3 without containing a hydrocarbon resin, the layer B is 100 wt % PP4, and the layer B′ is a blend of 98.33 wt % PP5 and 1.67 wt % POLYBATCH™ SPR6. The cast film line had three extruders 90/125/90 mm each having an L/D ratio of 32:1, which fed polymer into a feedblock. The feedblock diverted molten polymer from the extruder to a die having a width of 2.5 m. The molten polymer exited the die at a temperature of 250° C. and was cast on a chill roll at 30° C. The casting unit was equipped with adjustable winding speeds to obtain film having the targeted thickness. The film structure, layer composition, film thickness, and thickness ratios between layers for the comparative example film are shown in Table 3. The fabricated three-layer films were stabilized for one month, conditioned for at least 24 hours under 23° C., 50% relative humidity and measured for WVTR, OTR, NTR and aroma permeation according to the methods described herein. Results for WVTR, OTR and NTR are shown in Table 4, and results for aroma permeation is shown in Table 5.

### Example 2

Three-layer cast films having a B/A/B′ structure was fabricated in a cast film line, where the layer A is a blend of 83 wt % PP3 and 17 wt % HMB (the content of HCR is calculated as 10 wt %), the layer B is 100 wt % PP4, and the layer B′ is a blend of 98.33 wt % PP5 and 1.67 wt % POLYBATCH™ SPR6. The cast film line had three extruders 90/125/90 mm each having an L/D ratio of 32:1, which fed polymer into a feedblock. The feedblock diverted molten polymer from the extruder to a die having a width of 2.5 m. The molten polymer exited the die at a temperature of 250° C. and was cast on a chill roll at 30° C. The casting unit was equipped with adjustable winding speeds to obtain film having the targeted thickness. The film structure, layer composition, film thickness, and thickness ratios between layers for the comparative example film are shown in Table 3. The fabricated three-layer films were stabilized for one month, conditioned for at least 24 hours under 23° C., 50% relative humidity and measured for WVTR, OTR, NTR and aroma permeation according to the methods described herein. Results for WVTR, OTR and NTR are shown in Table 4, and results for aroma permeation is shown in Table 5.

### Example 3

Three-layer cast films having a B/A/B′ structure was fabricated in a cast film line, where the layer A is a blend of 75 wt % PP3 and 25 wt % HMB (the content of HCR is calculated as 15 wt %), the layer B is 100 wt % PP4, and the layer B′ is a blend of 98.33 wt % PP5 and 1.67 wt % POLYBATCH™ SPR6. The cast film line had three extruders 90/125/90 mm each having an L/D ratio of 32:1, which fed polymer into a feedblock. The feedblock diverted molten polymer from the extruder to a die having a width of 2.5 m. The molten polymer exited the die at a temperature of 250° C. and was cast on a chill roll at 30° C. The casting unit was equipped with adjustable winding speeds to obtain film having the targeted thickness. The film structure, layer composition, film thickness, and thickness ratios between layers for the comparative example film are shown in Table 3. The fabricated three-layer films were stabilized for one month, conditioned for at least 24 hours under 23° C., 50% relative humidity and measured for WVTR, OTR, NTR and aroma permeation according to the methods described herein. Results for WVTR, OTR and NTR are shown in Table 4, and results for aroma permeation is shown in Table 5.

### Example 4

Three-layer cast films having a B/A/C structure was fabricated in a cast film line, where the layer A is a blend of 83 wt % PP3 and 17 wt % HMB (the content of HCR is calculated as 10 wt %), the layer B is 100 wt % PP4, and the layer C is a blend of 93.33 wt % PBE1, 1.67 wt % POLYBATCH™ SPR6 and 5% POLYBATCH™ ABPP05 SC MED. The cast film line had three extruders 90/125/90 mm each having an L/D ratio of 32:1, which fed polymer into a feedblock. The feedblock diverted molten polymer from the extruder to a die having a width of 2.5 m. The molten polymer exited the die at a temperature of 250° C. and was cast on a chill roll at 30° C. The casting unit was equipped with adjustable winding speeds to obtain film having the targeted thickness. The film structure, layer composition, film thickness, and thickness ratios between layers for the comparative example film are shown in Table 3. The fabricated three-layer films were stabilized for one month, conditioned for at least 24 hours under 23° C., 50% relative humidity and measured for WVTR, OTR, NTR and aroma permeation according to the methods described herein. Results for WVTR, OTR and NTR are shown in Table 4, and results for aroma permeation is shown in Table 5.

TABLE 3
COMPOSITIONS AND STRUCTURES OF THE INVENTIVE FILMS

| Example | B12-Compar. | B13-Inventive | B14-Inventive | B17-Inventive |
|---|---|---|---|---|
| Thickness (μm) | 34 | 34 | 34 | 34 |
| Thickness ratios | B:A:B′ = 1:3:1 | B:A:B′ = 1:3:1 | B:A:B′ = 1:3:1 | B:A:C = 1:3:1 |
| layer C | — | — | — | PBE1 |
| | | | | (93 wt %) + |
| | | | | SMB(2%) + |
| | | | | ABMB(5%) |
| layer B′ | 98% PP5/ | 98% PP5/ | 98% PP5/ | — |
| | 2% SMB | 2% SMB | 2% SMB | |
| layer A | PP3 | PP3 (83 wt %) + | PP3 (75 wt %) + | PP3 (83 wt %) + |
| | (100 wt %) | HMB(17%) | HMB(25%) | HMB(17%) |
| layer B | PP4 | PP4 | PP4 | PP4 |
| | (100 wt %) | (100 wt %) | (100 wt %) | (100 wt %) |

It can be seen from WVTR data in Table 4 that the inventive examples containing a hydrocarbon resin have a lower water vapor transmission than that without hydrocarbon resin, which means they have improved barrier to water vapor permeation. Particularly, WVTR can be reduced around 30% when adding 10% hydrocarbon resin.

It can be seen from OTR data in Table 4 that the presence of hydrocarbon resin in the core increases significantly the barrier to oxygen. 10% hydrocarbon resin in the core of the inventive film generates a decrease of about 40% of the oxygen permeation through the film.

It can be seen from NTR data in Table 4 that the presence of hydrocarbon resin in the core increases significantly the barrier to nitrogen. 10% hydrocarbon resin in the core of the inventive film generates a decrease of about 37% of the nitrogen permeation through the film.

TABLE 4
WVTR, OTR AND NTR PROPERTIES OF THE INVENTIVE FILMS

| Example | B12-1 | B12-2 | B13-1 | B13-2 | B14-1 | B14-2 | B17-1 | B17-2 |
|---|---|---|---|---|---|---|---|---|
| WVTR gm/m^{2/}day | 12 | 12 | 8 | 8 | 7 | 8 | 9 | 10 |
| OTR (21% | 3,343 | 3,376 | 2,083 | 1,963 | 1,884 | 1,654 | 2,315 | 2,059 |
| O₂) cc/m²/day | | | | | | | | |
| NTR cc/m²/day | 448 | 480 | 288 | 259 | 292 | 258 | 304 | 288 |

As seen in Table 5, the inventive examples with addition of hydrocarbon resin in their core exhibit significantly lower aroma permeation values. 10% hydrocarbon resin in the core reduce the permeation rate of aromas by more than 50%, even for diphenyloxide there shows a permeation rate about 20%.

TABLE 5
AROMA PERMEATION OF THE INVENTIVE FILMS

| | Aroma Permeation μg/d*dm² | | | | | | | |
|---|---|---|---|---|---|---|---|---|
| | B12-1 | B12-2 | B13-1 | B13-2 | B14-1 | B14-2 | B17-1 | B17-2 |
| cis-3-Hexenol | 67 | 58 | 27 | 24 | 21 | 18 | 35 | 27 |
| Isoamylacetate | 30 | 27 | 13 | 12 | 11 | 10 | 17 | 15 |
| R + Limonene | 59 | 53 | 27 | 24 | 20 | 18 | 38 | 30 |
| Menthol | 248 | 214 | 93 | 80 | 67 | 58 | 112 | 87 |
| Citronellol | 617 | 542 | 239 | 205 | 172 | 152 | 285 | 228 |
| Linalylacetate | 206 | 183 | 93 | 70 | 68 | 60 | 105 | 87 |
| Diphenyloxide | 266 | 257 | 213 | 193 | 190 | 178 | 196 | 203 |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. For example, the compositions described herein may be free of any component, or composition not expressly recited or disclosed herein. Any method may lack any step not recited or disclosed herein. Likewise, the term “comprising” is considered synonymous with the term “including.” And whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A film comprising:
a first layer, A, which comprises from about 40 wt % to about 99 wt % of a propylene polymer and from about 1 to about 60 wt % of a hydrocarbon resin, based on the total weight of the first layer;
wherein the propylene polymer is a propylene homopolymer, or a copolymer of propylene having at least one comonomer selected from ethylene and C₄-C₂₀ alpha-olefins, wherein the copolymer has a propylene content of at least about 80 wt % and has a melting point of greater than about 115° C. and wherein the hydrocarbon resin is selected from the group consisting of an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and combinations thereof; and
wherein the film further comprises a second layer, B, comprising a copolymer of propylene and at least one comonomer selected from ethylene and C₄-C₂₀ alpha-olefins, wherein the propylene copolymer has a propylene content of at least about 80 wt % and has a melting point of greater than about 115° C.

2. The film of claim 1, wherein the propylene homopolymer has one or more of the following properties:
i) a melt flow rate MFR in the range of from about 1.5 dg/min to about 20 dg/min;
ii) a molecular weight distribution Mw/Mn ranging from about 1.9 to about 5;
and/or iii) a 1% secant flexural modulus ranging from about 500 MPa to about 2,000 MPa.

3. The film of claim 1, wherein the second layer, B, further comprises a hydrocarbon resin, which is selected from the group consisting of an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and a combination thereof.

4. The film of claim 1, wherein the propylene copolymer in the second layer, B, is a random copolymer of propylene.

5. The film of claim 1, wherein the film has a structure of BAB.

6. The film of claim 5, wherein the propylene copolymers of the two B layers are different.

7. The film of claim 1, wherein the film further comprises a third layer, C, wherein the third layer comprises a propylene-based elastomer, comprising propylene and at least one comonomer selected from ethylene and C₄-C₂₀ alpha-olefins, wherein the propylene-based elastomer has a propylene content of at least 75 wt %, an mm triad tacticity of greater than 75%, a melting point of less than 115° C., and a heat of fusion of less than 65 J/g.

8. The film of claim 7, wherein the film has the structure BAC or BABC.

9. The film of claim 7, wherein the film has the structure CBABC.

10. The film of claim 9, wherein the propylene-based elastomers of the two C layers are the same.

11. The film of claim 7, wherein the third layer, C, further comprises 0.01 wt % to 10 wt % of an additive, based on the total weight of the third layer, wherein the additive is a slip or antiblock additive.

12. The film of claim 1, wherein the hydrocarbon resin of the first layer, A, has a total dicyclopentadiene, cyclopentadiene, and methylcyclopentadiene derived content of from about 60 wt % to about 100 wt % based on the total weight of the hydrocarbon resin and wherein the hydrocarbon resin has a weight average molecular weight of from about 600 g/mole to about 1400 g/mole.

13. The film of claim 1, wherein the hydrocarbon resin is present in the first layer, A, in the amount from about 5 wt % to about 50 wt % based on the total weight of the first layer.

14. The film of claim 1, wherein the film has a permeation to water vapor greater than about 10% compared to the same film free of the hydrocarbon resin in the first layer.

15. The film of claim 1, wherein the film has a permeation to oxygen greater than about 10% compared to the same film free of the hydrocarbon resin in the first layer.

16. The film of claim 1, wherein the film has a permeation to nitrogen greater than about 10% compared to the same film substantially free of the hydrocarbon resin in the first layer.

17. The film of claim 1, wherein the film has a permeation to an aroma substance greater than about 20% compared to the same film substantially free of the hydrocarbon resin in the first layer.

18. The film of claim 17, wherein the aroma substance is selected from the group consisting of cis-3-hexenol, isoamylacetate, R+limonene, menthol, citronellol, linalylacetate, diphenyloxide, and combinations thereof.

19. A film comprising
(a) a core layer, comprising from about 40 wt % to about 99 wt % of a propylene polymer and from about 1 wt % to about 60 wt % of a hydrocarbon resin;
wherein the propylene polymer is a propylene homopolymer, or a copolymer of propylene having at least one comonomer selected from ethylene and C₄-C₂₀ alpha-olefins, wherein the copolymer has a propylene content of at least about 80 wt % and has a melting point of greater than about 115° C., and wherein the hydrocarbon resin is selected from the group consisting of: an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, and combinations thereof; and
(b) a sealing layer, wherein the sealing layer is laminated on the core layer.

20. An article made by the process of (a) forming the film of claim 19 into a bag shape; and (b) heat-sealing the facing surfaces of the sealing layer of the film.
